(19) United States
(12) Patent Application Publication
(10) Pub. No.: US 2026/0104074 A1
(43) Pub. Date: Apr. 16, 2026

(54) BEARING ELEMENT AND METHOD OF MANUFACTURING A BEARING ELEMENT

(71) Applicants: Mahle Engine Systems UK Limited, Warwickshire (GB); MAHLE International GmbH, Stuttgart (DE)

(72) Inventors: Peter Neal, Weedon (GB); Jeff Carter, Warwickshire (GB); James George, Rugby (GB)

(21) Appl. No.: 19/357,056

(22) Filed: Oct. 13, 2025

(30) Foreign Application Priority Data
Oct. 14, 2024 (GB) 2415094.8

(51) Int. Cl. F16C 33/20; F16C 33/12; F16C 33/14

(52) U.S. Cl. CPC F16C 33/206; F16C 33/127; F16C 33/14; F16C 33/208; F16C 2202/02; F16C 2204/12; F16C 2206/58; F16C 2208/42; F16C 2223/42; F16C 2223/70

(57) ABSTRACT

A bearing element is provided. The bearing element comprises a Cu-based lining; a polymer-based overlay; and a chemically resistant interlayer between the Cu-based lining and the polymer-based overlay. A method of manufacturing a bearing element is also provided.

### CROSS-REFERENCE TO RELATED APPLICATION

This application claims priority to United Kingdom Application No. 2415094.8, filed on Oct. 14, 2024, the contents of which is hereby incorporated by reference in its entirety.

### TECHNICAL FIELD

The disclosure relates to a bearing element, in particular a half bearing for a plain bearing, comprising a chemically resistant interlayer between a Cu-based lining and a polymer overlay. The bearing element is particularly suitable for use in engine oil which may be contaminated with water during normal operation.

The disclosure further relates to a method of manufacturing a bearing element.

### BACKGROUND

Plain bearings are used in many applications, such as for crankshaft journal bearings in internal-combustion engines. Plain bearings are usually in the form of two semi-cylindrical bearing shells and generally have a layered construction. The layered construction frequently comprises: a backing made from a strong backing material such as low carbon steel, of a thickness in the region of about 1 mm or more; a lining of a first bearing material adhered to the backing and of a thickness generally in the range from about 0.1 to 0.5 mm; and an overlay (also referred to as a sliding layer or running layer or bearing layer) supported by the lining and having a thickness of less than about 40 μm. The surface of the overlay forms the running or sliding surface with a cooperating shaft journal surface.

The backing provides strength and resistance to deformation of the bearing shell when it is installed in a main-bearing housing or in a connecting-rod big end, for example.

The lining may commonly be either an aluminium-based alloy or a copper alloy. Copper alloys, such as bronzes or brasses, are typically used in more highly-loaded bearings to provide additional support for the overlay.

The overlay is typically 6 to 25 μm thick and conventionally formed by a relatively soft metal layer, such as lead or a lead-tin alloy. A relatively soft overlay is used in order to provide conformability (the ability of the bearing to accommodate small misalignments between the bearing surface and the shaft journal) and embeddability (the ability to prevent debris or dirt particles, which may circulate in the lubricating oil, from scoring or damaging the journal surface by enabling such debris to embed in the bearing surface).

The sliding layer material may be a non-metallic, polymeric, material comprising a resin base, or matrix, and optionally one or more additives for enhancing the load carrying capacity and/or wear resistance of the bearing. Suitable polymer overlays are provided in published UK patent application nos. GB2465852 and GB2569158.

Plastics polymer overlay layers exhibit high wear resistance and fatigue strength. However, in some environments, polymer loss has surprisingly been observed by the inventors, exposing the lining layer. Polymer loss may be a particular problem in bearing applications in which water contamination may be present in engine oils at elevated temperature.

It is an object of the present invention to provide a bearing (element) which mitigates or prevents performance loss in polymer-on-bronze bearings.

### SUMMARY

The present disclosure, in a first aspect, provides a bearing element. In a second aspect, the present invention provides a method of manufacturing a bearing element. In a third aspect, the present disclosure provides a bearing. In a fourth aspect, the present disclosure provides a bearing element.

In particular, according to a first aspect, a bearing element is provided. The bearing element comprises a Cu-based lining; a polymer-based overlay; and a chemically resistant interlayer between the Cu-based lining and the polymer-based overlay.

Polymer-based overlays (sometimes referred to as plastics polymer overlay layers) exhibit high wear resistance and fatigue strength. However, in some test environments with water dilution of engine oils, localised regions of polymer loss have surprisingly been observed by the inventors. This may be a particular problem in sliding applications in which water contamination in engine oils at elevated temperature may result in chemical attack, leading to localised polymer loss.

By providing a chemically resistant interlayer between the Cu-based lining and the polymer-based overlay, polymer loss may be prevented or at least reduced significantly, so that the Cu-based lining is not exposed to the hot engine environment. This may improve the performance of the bearing element. In particular, full functionality of the overlay may be maintained for a longer period.

The inventors have found that by providing a chemically resistant interlayer between the polymer overlay and the Cu-based lining, in hot oil contamination testing with post soak tape test, described in detail below, bearing elements according to the present disclosure show no evidence of polymer loss, whereas prior art bearing elements without a chemically resistant interlayer show substrate exposure due to polymer loss.

The bearing element may be particularly suitable for use in, or when submerged in, engine oil, in particular when submerged in a low viscosity diesel engine oil contaminated with a small proportion of water (about 1 vol %) at temperatures of at least about 90° C.

Optionally, the chemically resistant interlayer may be a Ni-based interlayer. Advantageously, a Ni-based interlayer may prevent polymer loss and may be deposited with a suitable thickness, i.e. as a fairly thin layer. By providing a Ni-based chemically resistant interlayer, effects of the interlayer on the performance of the bearing element may be reduced, as a thin Ni-based interlayer does not affect mechanical properties or performance of the polymer overlay/Cu-based lining other than to prevent/minimise polymer loss.

The interlayer being a Ni-based interlayer may refer to the interlayer being a Ni interlayer. Alternatively, the interlayer being a Ni-based interlayer may refer to the interlayer comprising a relative majority of Ni, or comprising at least 50 mol % Ni. That is, the term “Ni-based interlayer” may refer to the interlayer being a Ni-alloy interlayer, such as a Ni-Cr interlayer, a Ni-Sn interlayer, a Ni-Mo interlayer, or the like.

Thus, the Ni-based interlayer may be one of: a Ni interlayer; a Ni-Sn-based interlayer; a Ni-Cr-based interlayer; or a Ni-Mo-based interlayer.

Other suitable chemically resistant interlayers may be Ag-based interlayers, Au-based interlayers, or Bi-based interlayers. For example, the chemically resistant interlayer may be an Ag interlayer, an Ag-based interlayer, a Bi-based interlayer, a Bi interlayer, or a Bi-Ag interlayer.

In one example, the bearing element may be a semi-cylindrical bearing shell, or half bearing, which may be coupled to a further semi-cylindrical bearing shell according to the present disclosure to form a complete/cylindrical bearing.

In another example, the bearing element may be a cylindrical bearing, which may be made up of two semi-cylindrical bearing shells.

The bearing element may be for, or may be a, plain, or sliding, bearing.

Bearing elements embodying the invention may also be used to form any of a number of sliding surfaces on engine components including bushes and piston skirts. They may also be used as, or as part of any of, thrust washers, flanges and half liners. Other suitable applications are envisaged and will be readily apparent to the skilled person.

The chemically resistant interlayer is preferably positioned directly on, i.e. adjacent to, the Cu-based lining. In other words, the chemically resistant interlayer may be bonded to the Cu-based lining.

The polymer-based overlay is preferably positioned directly on, i.e. adjacent to, the chemically resistant interlayer. In other words, the polymer-based overlayer may be bonded to the chemically resistant interlayer.

In other words, the chemically resistant interlayer may be provided on the bronze lining, and the polymer-based overlay may be provided on the chemically resistant interlayer.

The chemically resistant interlayer may comprise boron nitride.

The boron nitride may be hexagonal boron nitride (h-BN).

The boron nitride may be in the form of particles embedded in the interlayer. A diameter of the boron nitride particles may be less than a thickness of the interlayer.

Boron nitride may be beneficial, particularly where the particle morphology is in platelet form. Boron nitride, in particular hexagonal boron nitride (i.e. BN having hexagonal crystal structure, “h-BN”) and in platelet form, may enhance seizure and scuffing resistance.

The or a diameter D50 of the boron nitride particles is optionally less than 5 μm. The or a diameter of the boron nitride particles is optionally less than 3 μm. The or a diameter of the boron nitride particles is optionally less than 2 μm. The diameter D50 of the boron nitride particles is optionally 1.65 μm.

Optionally, the chemically resistant interlayer is an electrolytically-deposited interlayer. Advantageously, an electrolytically-deposited interlayer may be a sufficiently thin interlayer to prevent adverse effects on the mechanical properties and performance of the (other layers of the) bearing element, while ensuring complete coverage of the Cu-based lining, preventing polymer loss.

Further optionally, the electrolytically-deposited interlayer is an electroplated interlayer. Electroplating the interlayer may result in improved coverage and longevity of the interlayer, while permitting cost-effective manufacturing.

A first surface of the chemically-resistant interlayer, adjacent the polymer-based overlay, may be a roughened surface. Advantageously, by roughening a surface of the chemically-resistant interlayer, improved adhesion of the polymer-based overlay to the interlayer may be achieved.

In examples in which the interlayer is an electrolytically-deposited interlayer, in particular an electroplated interlayer, a surface of the interlayer is generally smooth. As such, for such electrolytically-deposited interlayers, surface roughening a first surface, adjacent the polymer-based overlay, may be particularly beneficial.

The roughened first surface may have a surface roughness Ra of at least about 0.1 μm. Optionally, the roughened first surface may have a surface roughness Ra of at least about 0.2 μm. Preferably, the roughened first surface has a surface roughness Ra of at least about 0.4 μm. Advantageously, the inventors have found that surprisingly, a surface roughness of at least about 0.4 μm prevents polymer loss.

The roughened first surface may have a surface roughness Ra of about 0.4 μm to about 1.0 μm. Further optionally, the roughened first surface may have a surface roughness Ra of about 0.4 μm to about 0.8 μm.

Optionally, the Cu-based lining is a bronze lining.

In some embodiments, the bronze lining may comprise at least 60 wt % Cu. In some embodiments, the bronze lining comprises at least 80 wt % Cu. In some embodiments, the bronze lining comprises at least 90 wt % Cu.

Optionally, the bronze lining may comprise up to about 10 wt % Sn. Further optionally, the bronze lining may comprise up to about 8 wt % Sn.

In some embodiments, the bronze lining may comprise about 3 wt % to about 5 wt % Sn.

In one example, the bronze lining may comprise: Sn 3 wt %-5 wt %; Bi 3 wt %-5 wt %; Ni 0.5 wt %-1.5 wt %; and Cu (remainder).

In some embodiments, the polymer-based overlay comprises polyamide-imide PAI. Preferably, the polymer-based overlay is formed of PAI (with optional additives).

In some embodiments, the polymer-based overlay comprises at least one of: melamine-cyanurate MCA; a metal powder; a fluoropolymer, optionally polytetrafluoroethylene PTFE or fluorinated ethylene-propylene FEP; a vinyl resin; MoS₂; and WS₂. Advantageously, additives may improve sliding properties and/or wear resistance of the polymer overlay.

In some examples, the polyimide/amide plastics overlay comprises about 5 vol % to less than 25 vol % of a metal powder and/or about 5 vol % to about 15 vol % solid lubricant (such as a fluoropolymer).

In a specific example, the polyimide/amide plastics overlay further comprises adding about 15 vol % metal powder and about 7-10 vol % solid lubricant.

The bearing element may further comprise a bearing backing, the Cu-based lining being provided on the bearing backing. Optionally, the bearing backing is a steel backing, in particular a carbon steel backing.

A thickness of the interlayer may be about 1 μm to about 10 μm. Optionally, a thickness of the interlayer may be about 3 μm to about 7 μm. Advantageously, an interlayer having a thickness in this range, in particular in the range of about 3 μm to about 7 μm, may provide sufficient chemical resistance to prevent polymer loss, while not affecting mechanical properties and performance of the bearing element in other ways.

In some examples, the thickness of the interlayer may be about 4 μm, or about 5 μm, or about 6 μm.

A thickness of the polymer-based overlay may be about 5 μm to about 25 μm. Optionally, a thickness of the polymer-based overlay may be about 8 μm to about 14 μm. Advantageously, an overlay thickness in this range may provide a suitable running layer.

According to a second aspect of the present disclosure, there is provided a method of manufacturing a bearing element, the method comprising: providing a Cu-based lining; depositing a chemically resistant interlayer on the Cu-based lining; and depositing a polymer-based overlay on the chemically resistant interlayer.

By providing a chemically resistant interlayer between the Cu-based lining and the polymer-based overlay, polymer loss is prevented or at least reduced significantly, so that the Cu-based lining is not exposed to the hot engine environment. This may increase reliability of the bearing element manufactured using the method according to the second aspect, by preventing exposure of the Cu-based lining. In particular, full functionality of the overlay may be maintained for a longer period.

The method may further comprise a step of roughening a surface of the chemically resistant interlayer before depositing the polymer-based overlay on the roughened surface of the chemically resistant interlayer. Advantageously, by roughening a surface, adhesion of the polymer-based overlay to the interlayer may be improved. As noted above, this is particularly advantageous when the chemically resistant interlayer is deposited in a way that would typically result in fairly low surface roughness, e.g. electrolytically.

Roughening the surface of the chemically resistant interlayer may comprises grit blasting the surface of the chemically resistant interlayer. Grit blasting may be a particularly suitable roughening method, because it is fast, and does not require any chemicals or acids.

The grit blasting step may be carried out according to the description in GB2465852A, which is incorporated herein by reference. The step of grit blasting may comprise the steps of degreasing and grit blasting with a fine Aluminium oxide powder.

The step of grit blasting may further comprise air washing the grit blasted surface to remove residual grit.

One suitable grit material may be fine Al₂O₃ grit (360).

The step of roughening the surface may comprise roughening the surface so that a surface roughness Ra of the roughened surface is at least about 0.1 μm, or at least about 0.2 μm, or at least about 0.4 μm.

In some examples, the step of grit blasting may be carried out so that a surface roughness Ra of the roughened surface is at least about 0.1 μm. Optionally, the step of grit blasting may be carried out so that a surface roughness Ra of the roughened surface is at least about 0.2 μm. Further optionally, the step of grit blasting may be carried out so that a surface roughness Ra of the roughened surface is at least about 0.4 μm.

Advantageously, the inventors have found that a surface roughness of at least about 0.1 μm improves adhesion of the polymer-based overlay to the chemically resistant interlayer. Indeed, a surface roughness of at least about 0.4 μm showed improved adhesion so that no polymer loss was observed during hot oil contamination testing with post soak tape test, described in detail below.

The step of roughening the surface, and optionally more specifically of grit blasting, may comprise roughening to a surface roughness Ra of about 0.4 μm to about 1.0 μm, and optionally of about 0.4 μm to about 0.8 μm.

In some embodiments, the step of depositing a chemically resistant interlayer on the Cu-based lining comprises electrolytically depositing the interlayer from an electrolyte. Advantageously, electrolytically depositing the interlayer may allow for a thin interlayer to be provided so that adverse effects on the mechanical properties and performance of the other layers of the bearing element are prevented or at least minimised, while ensuring complete and consistent coverage of the Cu-based lining so that sufficient chemical resistance is provided to prevent polymer loss.

The electrolyte may comprise boron nitride. In particular, the electrolyte may comprise hexagonal boron nitride (h-BN). As discussed above, inclusion of boron nitride in the electrolyte (and thus the interlayer) may enhance seizure and scuffing resistance.

Optionally, electrolytically depositing the interlayer comprises electroplating.

Electroplating advantageously permits deposition of a mechanically resistant interlayer, resulting in improved chemical resistance.

A suitable electroplating method is disclosed in GB2538283A, the description of which is incorporated herein by reference.

In some embodiments, the chemically resistant interlayer is a Ni-based interlayer. In embodiments in which the chemically resistant interlayer is a Ni-based interlayer and the interlayer is deposited from an electrolyte, the electrolyte comprises a Ni salt. For example, the electrolyte may comprise at least one of: NiSO₄; NiCl₂; Ni(CH₃CO₂)₂; and Ni(NO₃)₂.

In one embodiment, the electrolyte has an acidic pH.

Electrolytic deposition may be carried out at a current density of 0.5-50A/dm2.

Electrolytic deposition may be carried out at a temperature of less than 100 C, e.g. of between 50C and 90C.

A duration and a current density of the electrolytic deposition may be controlled to achieve a predetermined or desired interlayer thickness on the Cu-based (or bronze) bearing lining.

In other examples, for example where the chemically resistant interlayer is an Ag-based interlayer, the electrolyte comprises an Ag salt. For example, the electrolyte may comprise at least one of: AgNO₃; Ag₂SO₄; AgClO₄; and AgNO₃. In yet other examples, for example where the chemically resistant interlayer is a Bi-based interlayer, the electrolyte comprises a Bi salt. For example, the electrolyte may comprise at least one of: BiCl₂; and Bi(O₂CCH₃)₃.

Depositing a chemically resistant interlayer on the Cu-based lining may comprise depositing the chemically resistant interlayer having a thickness of about 1 μm to about 10 μm, optionally of about 3 μm to about 7 μm.

As set out above, if the chemically resistant interlayer is electrolytically deposited, the duration and current density of the electrolytic deposition may be controlled to achieve a desired interlayer thickness on the Cu-based bearing lining. Alternatively or additionally, as set out below, the viscosity of the polymer matrix, additives, and solvent mixture may be controlled to control a predetermined/desired final thickness after consolidation.

Depositing a polymer-based overlay on the chemically resistant interlayer may comprise depositing the polymer-based overlay having a thickness of about 5 μm to about 25 μm. Optionally, depositing a polymer-based overlay on the chemically resistant interlayer comprises depositing the polymer-based overlay having a thickness of about 6 μm to about 14 μm. Further optionally, depositing a polymer-based overlay on the chemically resistant interlayer comprises depositing the polymer-based overlay having a thickness of about 8 μm to about 14 μm.

A suitable method of application of a polymer overlay may be found in GB2569158A, the description of which is incorporated herein by reference.

In some embodiments, depositing a polymer-based overlay on the chemically resistant interlayer comprises: mixing a polyimide/amide plastics material with a solvent; and coating the solution onto the chemically resistant interlayer.

Advantageously, this method of coating with a polymer-based overlay may provide good coverage and is quick.

Coating the solution onto the chemically resistant interlayer may comprise spraying. Advantageously, spraying is a quick, inexpensive, and consistent method of applying a coating from a solution.

Coating the solution onto the chemically resistant interlayer may comprise coating a plurality of layers onto the chemically resistant interlayer to form the polymer-based overlay. Advantageously, by providing multiple layers, a thicker, more consistent overlay may be achieved.

Coating the solution onto the chemically resistant interlayer may further comprise a step of heating. Heating the coating may comprise a post coating oven cure. Heating, and in particular curing, the polymer-based overlay may remove solvent and permit crosslinking of the polymer matrix.

In some embodiments, the method further comprises a step of controlling the viscosity of the polymer matrix, additives and solvent mixture so as to attain a desired final thickness after consolidation.

Optionally, mixing the polyimide/amide plastics material with a solvent further comprises adding at least one of: melamine-cyanurate MCA; a metal powder; a fluoropolymer, optionally polytetrafluoroethylene PTFE or fluorinated ethylene-propylene FEP; a vinyl resin; MoS₂; and WS₂.

In some examples, mixing the polyimide/amide plastics material with a solvent further comprises adding about 5 vol % to less than 25 vol % of a metal powder and/or adding about 5 vol % to about 15 vol % solid lubricant (such as a fluoropolymer).

It is noted that the vol % of additives such as metal powders or solid lubricants refers to the volume portion of the additive in the polymer overlay.

In a specific example, mixing the polyimide/amide plastics material with a solvent further comprises adding about 15 vol % metal powder and about 7-10 vol % solid lubricant.

The method may further comprise a step of providing a bearing backing, and wherein the step of providing the Cu-based lining comprises providing the Cu-based lining on the bearing backing. Optionally, the bearing backing is a steel backing.

Optionally, the step of providing the Cu-based lining on the bearing backing may comprise one of: casting a Cu-based material onto the bearing backing, and sintering a copper-based powder onto the bearing backing.

In one particular example, providing the Cu-based lining on the bearing backing comprises casting a copper alloy onto a carbon steel backing. In such an example, the bronze lining may be referred to as a cast bronze lining.

In another particular example, providing the Cu-based lining on the bearing backing comprises sintering a copper powder onto a carbon steel backing. In such an example, the bronze lining may be referred to as a sintered bronze lining.

Providing the Cu-based lining may comprise providing a bronze lining.

According to a third aspect, there is provided a bearing, in particular a plain bearing. The bearing comprises a Cu-based lining; a polymer-based overlay; and a chemically resistant interlayer between the Cu-based lining and the polymer-based overlay.

According to a fourth aspect, there is provided a bearing element. The bearing element comprises a bronze lining; a Ni-based interlayer on the bronze lining; and a polymer-based overlay on the Ni-based interlayer.

The bronze lining may be provided on a bearing backing.

Any feature in one aspect of the invention may be applied to other aspects of the invention, in any appropriate combination. Furthermore, any, some and/or all features in one aspect may be applied to any, some and/or all features in any other aspect, in any appropriate combination. In particular, any method features provided in relation to the second aspect may be applied to any of the other aspects, and vice versa. Further particularly, any feature provided in relation to the first aspect may be applied to the third and fourth aspects.

It should also be appreciated that particular combinations of the various features described and defined in any aspects of the invention may be implemented and/or supplied and/or used independently.

Although the description of specific embodiments below may generally relate to one type of bearing half shells, bearing elements and methods embodying the present invention may also be used to manufacture other sliding elements such as, for example, flanged half bearings (e.g. flanged semi-annular bearings), bushings, and flanged bearings (e.g. flanged annular bearings).

### BRIEF DESCRIPTION OF THE DRAWINGS

The disclosure will be further described, by way of example only, with reference to the accompanying drawings, in which:

FIG. 1A shows a schematic perspective view of a bearing element, in particular a semi-cylindrical half bearing shell, which is one example of a bearing element according to the present disclosure;

FIG. 1B shows a schematic cross section of the bearing element of FIG. 1A;

FIG. 2 shows photographs of a bearing element with evidence of polymer loss, and of a bearing element according to the present disclosure, such as that of FIGS. 1A and 1B, showing no polymer loss;

FIG. 3 shows micrographs of a bearing element before hot oil contamination testing, and following the hot oil contamination testing with post soak tape testing, with evidence of polymer loss;

FIG. 4 shows micrographs of a bearing element according to the present disclosure, such as that of FIGS. 1A and 1B, before hot oil contamination testing, and following the hot oil contamination testing with post soak tape testing, showing no polymer loss;

FIG. 5 shows micrographs of a bronze lining and a chemically resistant interlayer having a roughened surface, before a polymer layer is deposited onto the roughened surface of the chemically resistant interlayer;

FIG. 6 shows a flow diagram of an example method according to the present disclosure; and

FIG. 7 shows a flow diagram of a further example method according to the present disclosure.

### DETAILED DESCRIPTION

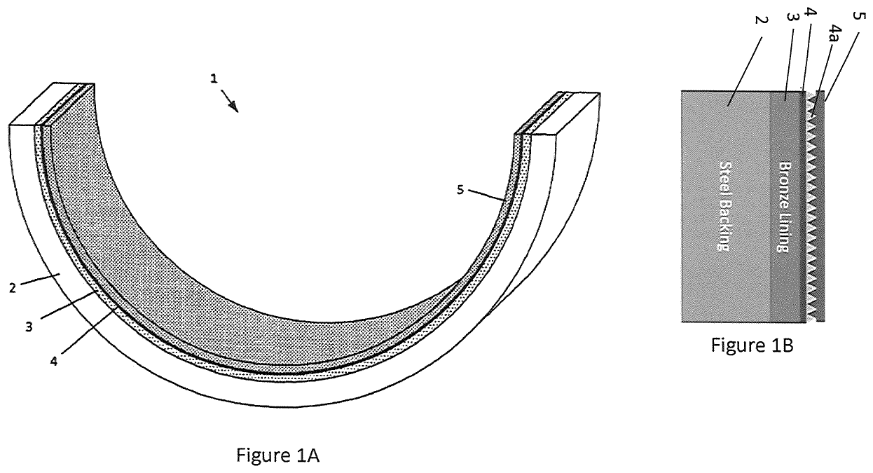

FIG. 1A schematically illustrates a semi-cylindrical bearing shell 1, which is also commonly referred to as a half bearing or a half shell. The bearing element 1 (which may also be referred to as a semi-cylindrical half bearing 1) comprises: a backing or base layer 2, formed of low-carbon steel; a bronze lining 3; a chemically resistant interlayer 4, formed of a Ni-based material; and a polymer overlay 5 or running/sliding layer.

FIG. 1B shows a schematic cross-section of the semi-cylindrical bearing shell 1, which schematically shows the steel backing layer 2, bronze lining 3, chemically resistant interlayer 4, and polymer overlay 5. Further, FIG. 1B also shows a roughened first surface 4a of the chemically resistant interlayer 4, with the surface roughness exaggerated in the schematic cross-section.

The roughened surface 4a of the chemically resistant interlayer 4 is roughened to a surface roughness Ra of at least about 0.4 μm, before the polymer overlay 5 is coated onto the roughened surface 4a. The surface 4a having a surface roughness of at least about 0.4 μm ensures sufficient adhesion between the interlayer 3 and the polymer overlay 5. In one specific example, the surface roughness Ra of the roughened surface 4a is about 0.4 μm to about 0.8 μm.

The polymeric overlay 5 is formed by depositing a bearing material comprising a polymeric PAI material dissolved in a solvent, in which fillers or additives such as solid lubricants or metal powder are suspended. Prior to deposition, e.g. by spraying, the melamine cyanurate particles (and any other suspended solid particulate) are preferably added to the PAI and maintained in suspension by agitation of the deposition mixture. One suitable solvent may be N-Ethyl Pyrrolidone. Another suitable solvent may be N-methyl pyrrolidone (NMP).

In one particular example, the polymeric overlay 5 comprises about 15 vol % metal powder and about 7-10 vol % solid lubricant.

Spraying of the polymer overlay 5 may be carried out using an automated air powered spray gun. The coating is built up in multiple layers with a flash off phase carried out between each layer to remove solvent. After the final coating thickness has been achieved the coating is given a final cure at a temperature of about 150° C. to about 250° C. for about 30 minutes to about 4 hours.

The inventors have found that in applications with high temperatures (e.g., >90° C.) in which engine oil contains water contaminations, known bearing elements with a polymer overlay on a bronze lining exhibit localised regions of polymer loss of the polymer overlay material.

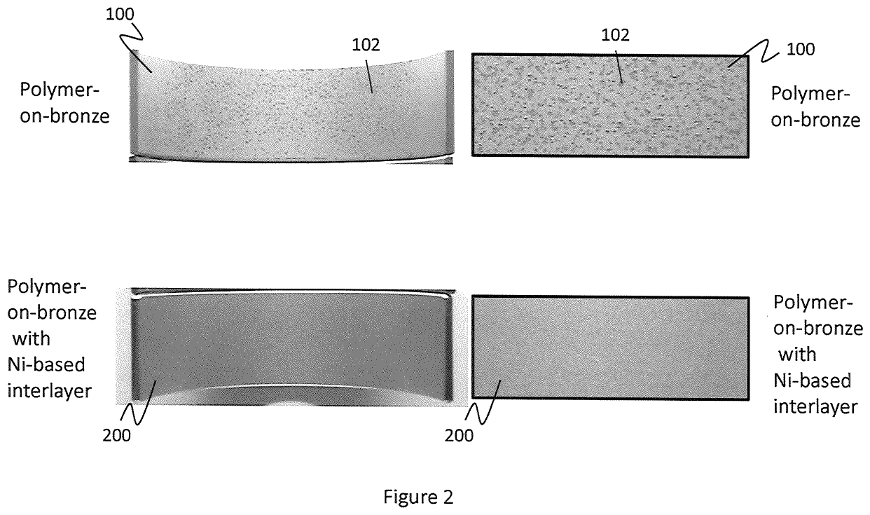

To show this effect of such environments on bearing elements, photographs of two bearing element specimens are shown in FIG. 2. The bearing element 100 is a semi-cylindrical bearing shell comprising a steel backing, a cast bronze lining directly on the steel backing, and a polymer overlay directly on the bronze lining.

As is apparent from the top two photographs of FIG. 2, upon hot oil contamination testing with post soak tape test (described in detail below), the known “polymer-on-bronze” bearing element 100 shows localised regions of polymer loss, exposing the cast bronze lining.

The bottom two photographs show that, in contrast, the running layer/polymer overlay of a bearing element 200 according to the present disclosure, such as the semi-cylindrical bearing shell shown, remains unaffected by the hot oil contamination testing with post soak tape test. There is no evidence of polymer loss and thus no exposure of the cast bronze lining is observed.

Hot oil contamination testing with post soak tape test

Before hot oil contamination testing with post soak tape test, a test bearing specimen (such as 100, 150, or 200) is cleaned using distilled water or a weak solvent, and tape is applied to the circumference of the part. The bearing is secured in a vice, and the tape is pulled off in a single operation. The polymer surface and tape are both inspected for either transfer of polymer to the tape or substrate exposure. If there is polymer loss, then the part has failed, and is not submitted to the hot oil contamination testing. Polymer loss during the initial tape testing indicates insufficient adhesion of the polymer overlay to the lining or interlayer.

After the initial tape testing, a test bearing specimen is soaked in engine oil, contaminated with 1 vol % water. The test vat is continually stirred and heated to a temperature >90°C. The test bearing specimen is soaked for >100 hrs.

Following the soak, the bearing specimen is inspected, cleaned (using distilled water or a weak solvent) and the tape test described above is repeated. Both the tape and the bearing specimen are inspected for polymer loss and polymer transfer to the tape. The results are recorded by photographs.

Any suitable tape may be used. The tape used for the tape test of the specimens shown in FIG. 2 is a performance tape.

The oil used is a low viscosity, heavy duty diesel engine oil which meets current heavy-duty engine specifications. An example of such an oil comprises a synthetic base oil (Group III or Group IV oils) and polyalphaolefins (PAO). In various examples, such an oil may comprise a variety of additives and performance enhancers.

The polymer-on-bronze bearing elements 100, 150 showed polymer loss and bronze exposure. Detachment of the polymer overlay, and exposure of the bronze lining, may result in reduced performance. By exposing the bronze lining, the lining becomes susceptible to chemical attack from the challenging environment (high temperature, low viscosity engine oil with water contamination).

On the other hand, bearing elements 200 according to the present disclosure, which include a chemically resistant interlayer as a barrier between the polymer overlay and the bronze lining (“polymer-on-interlayer-on-bronze” bearing elements), showed no substrate exposure or polymer loss, thus resulting in improved performance and reliability.

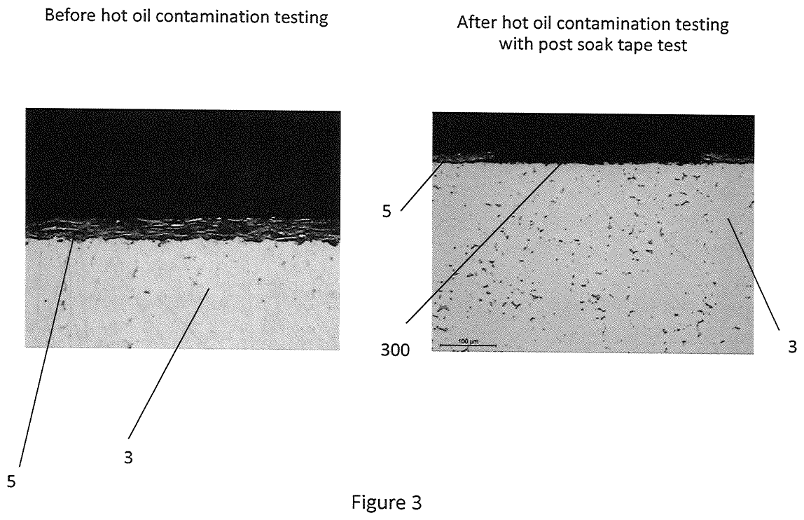

The above discussed results were confirmed by micrographs of metallurgical sections of respective polymer-on-bronze bearing elements, shown in FIG. 3, before the hot oil contamination testing (left) having a bronze lining 3 and a continuous polymer overlay 5 on the bronze lining. However, following the hot oil contamination testing with post soak tape testing (right in FIG. 3), the polymer overlay 5 of the “polymer-on-bronze” bearing element shows significant discontinuity, with localised portions of the polymer overlay 5 lost, exposing the bronze lining through gaps 300 in the polymer overlay 5.

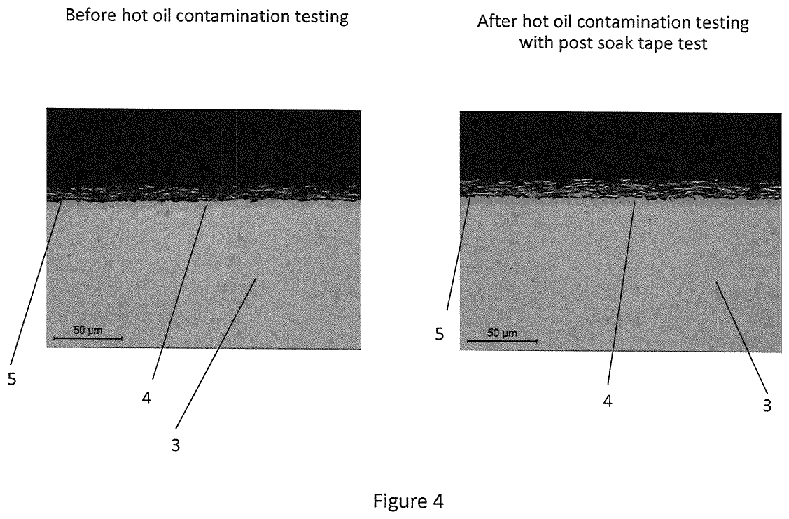

On the other hand, as shown in the micrographs of metallurgical sections of FIG. 4, in example bearing elements according to the present disclosure, which comprise a bronze lining 3, a Ni-based interlayer 4, and a polymer overlay 5, any differences between the samples before and after the hot oil contamination testing with post soak tape test are negligible. There is no loss of polymer, and no part of the bronze lining 3 (or even of the Ni-based interlayer 4) is exposed.

Thus, while the polymer loss of polymer-on-bronze bearing elements results in bronze lining exposure, which may result in reduced performance, the sliding qualities of the polymer overlay 5 of the “polymer-on-interlayer-on-bronze” bearings according to the present disclosure remain unaffected. The chemically resistant interlayer 4 prevents chemical attack (caused by the motor oil with water contamination at high temperatures over a prolong period of time), ensuring that the polymer overlay 5 remains continuously adhered to the interlayer (and thus the lining).

The inventors have found that without the water contamination in the engine oil, no polymer damage is observed, even for the polymer-on-bronze bearing elements.

Although the inventors have found that the quantity of polymer loss is related to both soaking time and soaking temperature, the inventors have found a bias towards temperature having the greatest influence on the environment and thus the polymer loss.

Grit blasting and surface roughness

As already set out above, a surface of the chemically resistant interlayer 4 on which the polymer overlay 5 is coated is roughened, i.e. a roughness Ra of the surface is increased, by grit blasting. Roughening the surface permits improved adherence of the polymer overlay 5 to the interlayer 4.

A minimum roughness to provide desirable adhesion may be Ra of about 0.4 um, measured according to EN ISO 4287 with a cut off length of 0.25 mm.

The grit blasting process is substantially as described in GB2465852A, the description of which is incorporated herein. To prepare the roughened surface for coating with the polymer overlay, the chemically resistant interlayer is degreased and then grit blasted with a fine Al₂O₃ grit (360) using a standard grit blasting process. Any residual grit is removed by an air blast. The grit rating used may differ from that of GB2465852A—a particularly suitable grit may be fine Aluminium oxide, with any residual grit removed by air wash.

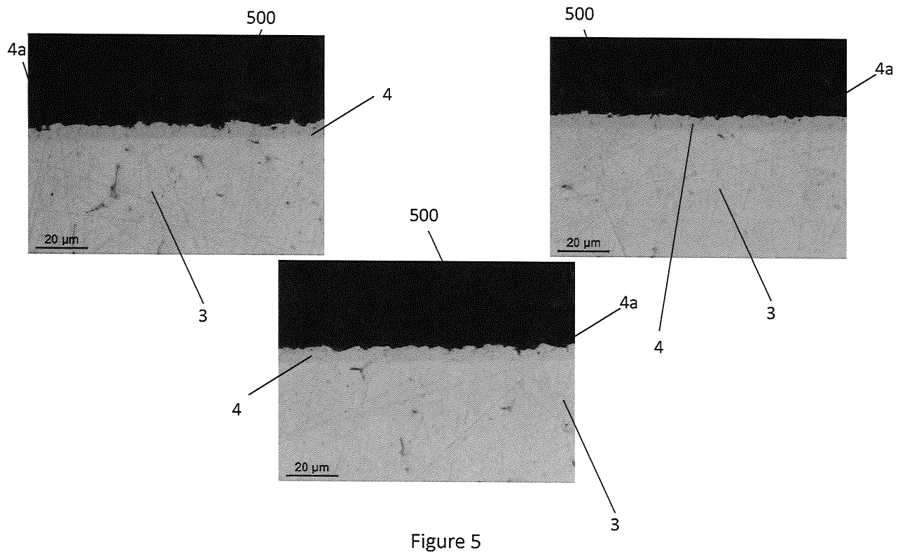

The effect of grit blasting on a surface roughness of a surface of the Ni-based interlayer is shown in the micrographs of the metallurgical sections of FIG. 5. As is apparent from the micrographs, the roughened surface 4a of the Ni-based interlayer 4, which is deposited directly onto the bronze lining 3 by electroplating, contains various surface features such as peaks and valleys, resulting in increased surface roughness Ra. The surface features allow for improved adhesion of the polymer overlay 5 (not shown in the micrographs of FIG. 5) to the Ni-based interlayer 4.

In a particular example of a bearing element according to the disclosure, the bearing element is a semi-cylindrical bearing shell for use with low viscosity heavy duty diesel engine oil meeting latest heavy-duty engine specifications. In such applications, engine oil may comprise about, or up to, 1 vol % water dilution.

In this particular example, the backing is made of low carbon steel, with a thickness of about 1 to 5 mm. The lining is a bronze lining comprising 3 wt %-5 wt % Sn, 3 wt %-5 wt % Bi, 0.5 wt %-1.5 wt % Ni, and the remainder Cu. The lining has a thickness of about 300 μm. The interlayer is an electroplated layer of Ni, having a thickness of about 6 μm. The interlayer has a grit blasted (roughened) surface having a surface roughness Ra greater than about 0.4 μm, measured according to EN ISO 4287 with a cut off length of 0.25 mm. The overlay coating has a thickness of 12 μm, and comprises: PAI 55-65 wt %, Al 24-28 wt %, Solid lubricant 8-12 wt %, and Silane 4-6 wt %.

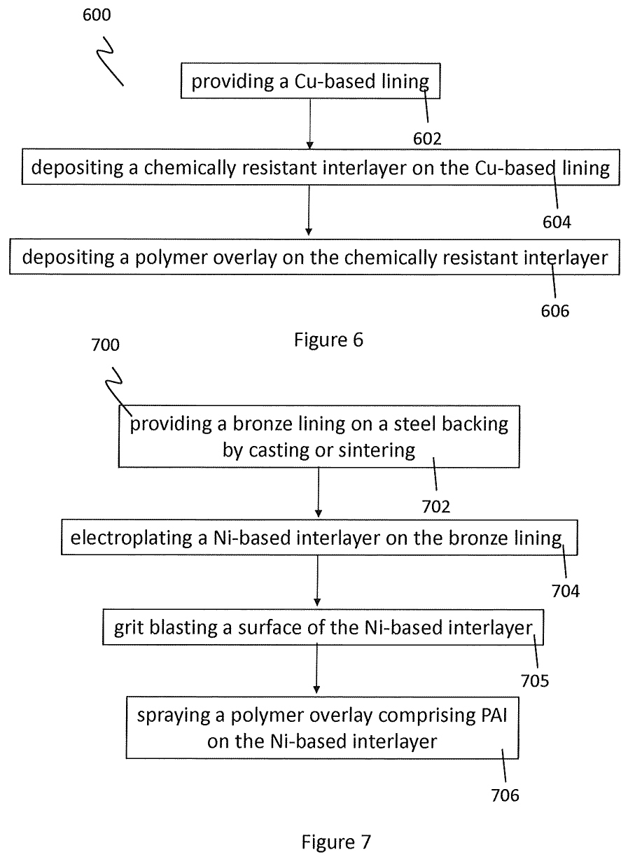

FIG. 6 shows a flow diagram of an example method 600 for manufacturing a bearing element according to the disclosure, such as bearing element 1 or bearing element 200. The method 600 comprises providing 602 a Cu-based lining. The method 600 further comprises depositing 604, e.g. electrolytically, a chemically resistant interlayer on the Cu-based lining. The method 600 further comprises depositing 606, e.g. by spraying, a polymer overlay on the chemically resistant interlayer.

FIG. 7 shows a flow diagram of a further example method 700 for manufacturing a bearing element according to the disclosure. The method 700 comprises providing 702 a bronze lining on a steel backing by casting or sintering. The steel backing may be a carbon steel backing, and in particular a low carbon steel backing.

Method 700 further comprises electroplating 704, from an electrolyte comprising NiSO₄, a Ni-based interlayer on the bronze lining. The method 700 further comprises grit blasting 705 a surface of the Ni-based interlayer deposited in step 704, to increase its surface roughness. The surface roughness Ra may be increase so that it is at least 0.4 μm, and in particular about 0.4 μm to about 0.8 μm.

The method 700 further comprises spraying 706 a polymer overlay comprising PAI on the (roughened surface of the) Ni-based interlayer. Spraying 706 a polymer overlay may comprise consecutively spraying a plurality of layers of polymer solution. Spaying 706 may further comprise at least one step of flashing off to remove solvent. If spraying 706 comprises spraying a plurality of layers, then spraying 706 may comprise a plurality of corresponding flashing off steps.

Although described herein and illustrated in the drawing in relation to a half bearing shell, methods or bearing elements embodying the present disclosure may equally be used to manufacture other sliding elements, including, for example, bushes, and engines comprising such sliding engine components.

Further features of the disclosure are defined in the following list of numbered clauses, and numbered sub-clauses:

Various examples/embodiments are described herein for various apparatuses, systems, and/or methods. Numerous specific details are set forth to provide a thorough understanding of the overall structure, function, manufacture, and use of the examples/embodiments as described in the specification and illustrated in the accompanying drawings. It will be understood by those skilled in the art, however, that the examples/embodiments may be practiced without such specific details. In other instances, well-known operations, components, and elements have not been described in detail so as not to obscure the examples/embodiments described in the specification. Those of ordinary skill in the art will understand that the examples/embodiments described and illustrated herein are non-limiting examples, and thus it can be appreciated that the specific structural and functional details disclosed herein may be representative and do not necessarily limit the scope of the embodiments.

Reference throughout the specification to “examples, “in examples,” “with examples,” “various embodiments,” “with embodiments,” “in embodiments,” or “an embodiment,” or the like, means that a particular feature, structure, or characteristic described in connection with the example/embodiment is included in at least one embodiment. Thus, appearances of the phrases “examples, “in examples,” “with examples,” “in various embodiments,” “with embodiments,” “in embodiments,” or “an embodiment,” or the like, in places throughout the specification are not necessarily all referring to the same embodiment. Furthermore, the particular features, structures, or characteristics may be combined in any suitable manner in one or more examples/embodiments. Thus, the particular features, structures, or characteristics illustrated or described in connection with one embodiment/example may be combined, in whole or in part, with the features, structures, functions, and/or characteristics of one or more other embodiments/examples without limitation given that such combination is not illogical or non-functional. Moreover, many modifications may be made to adapt a particular situation or material to the teachings of the present disclosure without departing from the scope thereof.

It should be understood that references to a single element are not necessarily so limited and may include one or more of such element. Any directional references (e.g., plus, minus, upper, lower, upward, downward, left, right, leftward, rightward, top, bottom, above, below, vertical, horizontal, clockwise, and counterclockwise) are only used for identification purposes to aid the reader's understanding of the present disclosure, and do not create limitations, particularly as to the position, orientation, or use of examples/embodiments.

“One or more” includes a function being performed by one element, a function being performed by more than one element, e.g., in a distributed fashion, several functions being performed by one element, several functions being performed by several elements, or any combination of the above.

It will also be understood that, although the terms first, second, etc. are, in some instances, used herein to describe various elements, these elements should not be limited by these terms. These terms are only used to distinguish one element from another. For example, a first element could be termed a second element, and, similarly, a second element could be termed a first element, without departing from the scope of the various described embodiments. The first element and the second element are both elements, but they are not the same element.

The terminology used in the description of the various described embodiments herein is for the purpose of describing particular embodiments only and is not intended to be limiting. As used in the description of the various described embodiments and the appended claims, the singular forms “a”, “an” and “the” are intended to include the plural forms as well, unless the context clearly indicates otherwise. It will also be understood that the phrase at least one of successive elements separated by the word “and” (e.g., “at least one of A and B”) is to be interpreted the same as the term “and/or” and as used herein refers to and encompasses any and all possible combinations of one or more of the associated listed items. It will be further understood that the terms “includes,” “including,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof.

Joinder references (e.g., attached, coupled, connected, and the like) are to be construed broadly and may include intermediate members between a connection of elements, relative movement between elements, direct connections, indirect connections, fixed connections, movable connections, operative connections, indirect contact, and/or direct contact. As such, joinder references do not necessarily imply that two elements are directly connected/coupled and in fixed relation to each other. Connections of electrical components, if any, may include mechanical connections, electrical connections, wired connections, and/or wireless connections, among others. Uses of “e.g. ” and “such as” in the specification are to be construed broadly and are used to provide non-limiting examples of embodiments of the disclosure, and the disclosure is not limited to such examples.

While processes, systems, and methods may be described herein in connection with one or more steps in a particular sequence, it should be understood that such methods may be practiced with the steps in a different order, with certain steps performed simultaneously, with additional steps, and/or with certain described steps omitted.

As used herein, the term “if” is, optionally, construed to mean “when” or “upon” or “in response to determining” or “in response to detecting,” depending on the context.

Similarly, the phrase “if it is determined” or “if [a stated condition or event] is detected” is, optionally, construed to mean “upon determining” or “in response to determining” or “upon detecting [the stated condition or event]” or “in response to detecting [the stated condition or event],” depending on the context. All matter contained in the above description or shown in the accompanying drawings shall be interpreted as illustrative only and not limiting. Changes in detail or structure may be made without departing from the present disclosure.

1. A bearing element comprising:
a Cu-based lining;
a polymer-based overlay; and
a chemically resistant interlayer disposed between the Cu-based lining and the polymer-based overlay.

2. The bearing element of claim 1, wherein the chemically resistant interlayer comprises a Ni-based interlayer.

3. The bearing element of claim 2, wherein the Ni-based interlayer comprises boron nitride.

4. The bearing element of claim 1, wherein the chemically resistant interlayer comprises at least one of: a Bi-based interlayer or an Ag-based interlayer.

5. The bearing element of claim 1, wherein the chemically resistant interlayer comprises an electroplated interlayer.

6. The bearing element of claim 1, wherein a first surface of the chemically resistant interlayer, adjacent the polymer-based overlay, comprises a roughened surface having a surface roughness Ra of at least about 0.4 μm.

7. The bearing element of claim 1, wherein the Cu-based lining comprises a bronze lining, wherein the bronze lining comprises at least 80 wt % Cu or at least 90 wt % Cu.

8. The bearing element of claim 1, wherein the polymer-based overlay comprises polyamide-imide PAI.

9. The bearing element of claim 1, wherein a thickness of the chemically resistant interlayer is about 1 μm to about 10 μm.

10. The bearing element of claim 1, wherein a thickness of the polymer-based overlay is about 5 μm to about 25 μm.

11. A method of manufacturing a bearing element, comprising:
providing a Cu-based lining;
depositing a chemically resistant interlayer on the Cu-based lining; and
depositing a polymer-based overlay on the chemically resistant interlayer.

12. The method of claim 11, further comprising roughening a first surface of the chemically resistant interlayer before depositing the polymer-based overlay on the first surface of the chemically resistant interlayer.

13. The method of claim 11, wherein depositing the chemically resistant interlayer comprises electroplating the chemically resistant interlayer onto the Cu-based lining using an electrolyte, the electrolyte including at least one of: boron nitride or hexagonal boron nitride.

14. The method of claim 11, wherein the chemically resistant interlayer comprises a Ni-based interlayer.

15. The method of claim 11, wherein depositing the polymer-based overlay on the chemically resistant interlayer comprises:
mixing a polyimide/amide plastics material with a solvent to produce a solution; and
spraying the solution onto the chemically resistant interlayer.

16. The bearing element of claim 2, wherein the Ni-based interlayer comprises at least one of:
a Ni interlayer, a Ni-Sn-based interlayer, a Ni-Cr-based interlayer, or a Ni-Mo-based interlayer.

17. The bearing element of claim 2, wherein the Ni-based interlayer comprises hexagonal boron nitride.

18. The bearing element of claim 8, wherein the polymer-based overlay further comprises at least one of: melamine-cyanurate MCA, a metal powder, or a fluoropolymer.

19. The bearing element of claim 8, wherein the polymer-based overlay further comprises at least one of: melamine-cyanurate MCA, a metal powder, a fluoropolymer, polytetrafluoroethylene PTFE, fluorinated ethylene-propylene FEP, a vinyl resin, MoS₂, or WS₂.

20. The method of claim 12, wherein roughening the first surface of the chemically resistant interlayer comprises grit blasting the surface of the chemically resistant interlayer.
